(19) United States
(12) Patent Application Publication
(10) Pub. No.: US 2005/0119936 A1
(43) Pub. Date: Jun. 2, 2005

(54) Sponsored media content

(76) Inventors: Robert Buchanan, San Diego, CA (US); Robin Buchanan, San Diego, CA (US)

Correspondence Address: FISH & RICHARDSON, PC, 12390 EL CAMINO REAL, SAN DIEGO, CA, 92130-2081, US

(21) Appl. No.: 10/727,196

(22) Filed: Dec. 2, 2003

(51) Int. Cl. G06F 17/60

(52) U.S. Cl. 705/14

(57) ABSTRACT

A method for allowing a user to download authorized media content from one or more websites without a fee includes a sponsor paying the fee for the downloaded authorized media content in exchange for the user playing one or more advertisements in their entirety. In one implementation, a method includes selecting downloadable media content from a graphical user interface, and playing one or more advertisements in their entirety on one or more computers. The method further includes accessing the media content upon playing the one or more advertisements in their entirety, in which a fee for the media content is paid by a sponsor in exchange for a user playing the one or more advertisements in their entirety before the media content is accessed.

### CROSS REFERENCE TO RELATED APPLICATIONS

This application claims the benefit of priority from U.S. Provisional Application entitled “SPONSORED MEDIA CONTENT”, filed Dec. 2, 2003 by Robert C. Buchanan and Robin D. Buchanan, the disclosure of which is incorporated by reference.

### TECHNICAL FIELD

The present disclosure relates to media content, in particular media content that is sponsored in order to be accessed by one or more users.

### BACKGROUND

In recent times, new technologies (e.g., internet tools and applications) and services (e.g., services via internet sites) have permitted the delivery of media content to internet users. For instance, internet users can use the internet to download various forms of media content to their computers.

The media content may include various forms of audio content (e.g., music and recordings), video content (e.g., movies, music videos, video programs, commercials), and literature and reading material stored in various file formats (e.g., a document in a Word format provided by Microsoft Corporation of Redmond Washington). In the case of downloadable music and movie content, much legal controversy has arisen recently because some of this media content has been shared among various computer users without the consent of the owner, creator, and/or licensed party of the content and/or in violation of copyright laws. In turn, some computer users are storing and sharing “pirated” music and movies for free without properly compensating the copyright holders. Hence, there are artists, labels, and production companies that do not collect a fee when their content is “pirated.”

### SUMMARY

The present disclosure describes a method that, in one implementation, includes receiving a selection of media content from a graphical user interface (GUI), wherein the media content is configured to be downloadable onto one or more computers. The method includes providing one or more advertisements that are capable of being played and providing access to the media content upon playing the one or more advertisements in their entirety. A fee (or payment) for the media content is received from a sponsor in exchange for a user playing the one or more advertisements in their entirety before the media content is accessed. The user receives the media content without paying a fee for the media content. In one case, a sponsor agrees to provide compensation for the media content in exchange for a user playing the one or more advertisements in their entirety before the media content is accessed, in which the compensation is a payment to at least one of an intermediary distributor and one or more initial owners and producers of the media content.

When providing access to the media content upon playing the one or more advertisements in their entirety, the media content can be downloaded after, during, or before playing the one or more advertisements in their entirety. But, the one or more advertisements must be played in their entirety before the user is allowed to view, play, or duplicate (or the like) the media content. In one case, the one or more advertisements are in a streaming video format. In another case, the one or more advertisements are downloaded along with the media content, in which the completion of the playing of the one or more advertisements permits the media content to be “unlocked” for use. The user is prevented from unlocking the media content until after the user plays the one or more advertisements in their entirety.

The selection of media content may include multiple media content selections. The media content can include audio content, video content, text-based content, and/or gaming content.

The sponsor can pass the one or more advertisements to an intermediary distributor, in which the intermediary distributor delivers the one or more advertisements to the user. The intermediary distributor can categorize and deliver the one or more advertisements based on the specifications of the sponsor. The one or more advertisements may be targeted for one or more user preferences. The one or more advertisements can also be tailored to one or more user profiles. The user may be required to register user information (e.g., one or more user preferences and an email address) before selecting the media content.

The media content may be selected from an independent website, in which the independent website can host the media content, and the intermediary distributor can deliver one or more advertisements. In another case, the media content selected in the graphical user interface can be selected from the intermediary distributor, in which the intermediary distributor can deliver the media content and one or more advertisements to the user. The intermediary distributor can receive the fee from the sponsor and compensate one or more initial owners and producers of the media content with a portion of the fee. The download of the media content can therefore be authorized by the one or more initial owners and producers of the media content. In playing one or more advertisements in their entirety, the user is not permitted to terminate the play of the one or more advertisements until the one or more advertisements have reached the end of play.

In another implementation, the present disclosure describes a system that includes a user interface adapted to collect data from a user. The collected data includes one or more selections for downloadable media content. The system includes an intermediary distributor that sends one or more advertisements to the user. The system further includes a sponsor to compensate the intermediary distributor for the downloadable media content in exchange for the user playing the one or more advertisements in their entirety. The user does not pay a fee to download the downloadable media content.

The intermediary distributor can include a database to store a number of media content and advertisements. The advertisements and/or the media content may be categorized based on specifications of one or more sponsors. The intermediary distributor may provide the media content for downloading to the user. The intermediary distributor may also receive one or more advertisements from a sponsor and/or an advertiser.

In another case, the system may also include an independent website. The independent website can host the downloadable media content, and the intermediary distributor can pass one or more advertisements to the independent website. The user can interact with the independent website for downloading media content.

The one or more advertisements can be targeted for the user, and the intermediary distributor can have one or more tools and resources to match a user profile to cataloged advertisements in the intermediary distributor's database. The intermediary distributor may also provide a ranking of downloadable media content to the sponsor based on a frequency of download.

In another implementation, a system includes the following tools: a first tool to enable the authorized downloading of media content for one or more users; a second tool to enable one or more users to register user information; and a third tool to deliver one or more advertisements to one or more users. The authorized downloading of media content is paid (or agreed to be paid) by a sponsor that requires the one or more users to play the one or more advertisements in their entirety before accessing the media content. The system may enable the authorized downloading of media content to one or more users without requiring a fee or payment from the one or more users after the one or more users play the one or more advertisements in their entirety. In another case, the system may enable the authorized downloading of media content and reduce a fee for (or a payment from) the one or more users for the media content after the one or more users play the one or more advertisements in their entirety.

The system may further include a graphical user interface to enable a user to select media content for downloading. The system may include a fourth tool to automatically compensate one or more initial producers of the media content with a portion of the payment from the sponsor. The system may also include a fifth tool to enable an assessment of a frequency of downloads. The fifth tool may include a scale with one or more ranges of popularity (e.g., a number of downloads in a given time frame). The fifth tool may also include one or more download parameters. One or more advertisements may be assigned based on one or more ranges of popularity. The system may include a sixth tool that maintains a number of credits in a user's account based on a number of advertisements played and a number of downloaded media content. The playing of an advertisement can add credits to the user's account and the downloading of media content can deduct credits from the user's account.

The present disclosure also describes an article that includes a machine-readable medium storing instructions operable to cause a machine to perform operations such as receiving a selection of media content from a graphical user interface, wherein the media content is configured to be downloadable onto one or more computers. The operations also include providing one or more advertisements that are capable of being played and providing access to the media content upon playing the one or more advertisements in their entirety. A fee for the media content is received from a sponsor in exchange for a user playing the one or more advertisements in their entirety before the media content is accessed. The user receives the media content without paying a fee for the media content. The sponsors can be charged for the media content download.

The systems and techniques described here may provide one or more of the following technical advantages. For example, computer users can benefit because they can download media content with the authorization of the copyright holder and perform that download without a fee. Sponsors can benefit in that the advertising can reach targeted markets via the registered information that the users provide. Advertisers can be assured that their advertisements are actually received and viewed (and/or heard) by the user, and not ignored by their targeted audience. The copyright holders (e.g., artists, labels, and production companies) can benefit in that they can be compensated for their work via a billing and payment system from an intermediary distributor. Other parties may benefit from a reduction in litigation concerning the unauthorized downloading and distribution of media content.

Details of one or more implementations are set forth in the accompanying drawings and the description below. Other features and advantages will be apparent from the description and drawings, and from the claims.

### DRAWING DESCRIPTIONS

FIG. 1 shows an exemplary block diagram of the sponsored media content system.

FIG. 2 shows an exemplary flow diagram for a user receiving media content.

FIG. 3 shows an exemplary flow diagram for a sponsor sending advertisements to an intermediary distributor.

FIGS. 4A and 4B show exemplary diagrams of how the intermediary distributor assesses downloadable media content.

FIG. 5 shows an exemplary interface for the user.

Like reference symbols in the various drawings indicate like elements.

### DETAILED DESCRIPTION

The following detailed description makes reference to the accompanying drawings. Other embodiments of the present invention are possible and modifications may be made to the embodiments without departing from the spirit and scope of the invention. Therefore, the following detailed description is not meant to limit the invention. Rather the scope of the invention is defined by the appended claims.

Moreover, for convenience in the ensuing description, some explanations of terms are provided herein. However, the explanations contained herein are intended to be exemplary only. They are not intended to limit the terms as they are described or referred to throughout the specification. Rather these explanations are meant to include any additional aspects and/or examples of the terms as described and claimed herein and/or as used by one of skill in the art.

The following describes various tasks, techniques, and systems relating to sponsored media content. The present disclosure describes methods and systems in which online media content that is downloaded and/or distributed can be legally obtained by a computer user through one or more websites or computers and paid for by a sponsor. The payment by the sponsor can be used in compensating the copyright holder and/or obtaining permission from the copyright holder. In one implementation, a method can allow computer users to request, download, and distribute media content, in which the fee/compensation for the content is paid by a sponsor in exchange for the user agreeing to play (e.g., to view and/or hear) the advertisements (e.g., solicitations and/or web commercials) from that sponsor before accessing the requested media content.

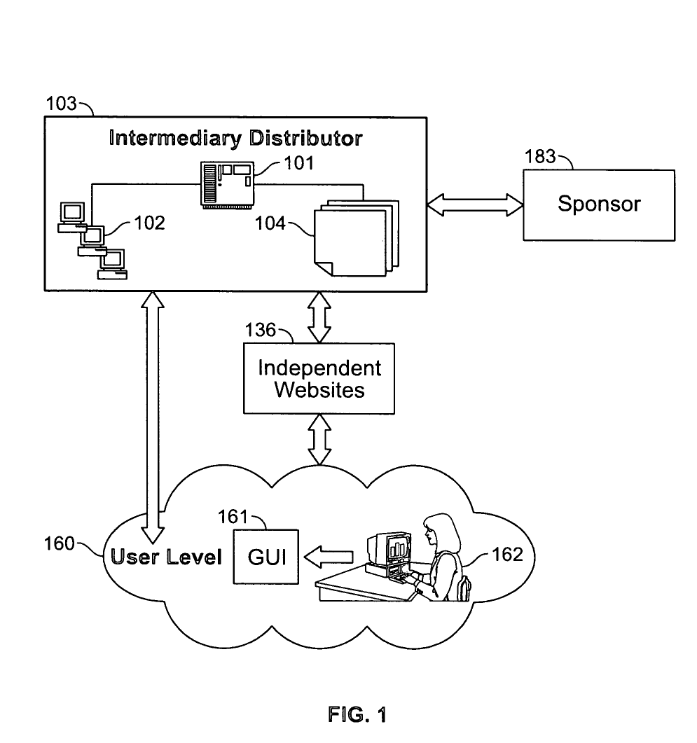

FIG. 1 shows an exemplary block diagram of a sponsored media content system. The system can have an intermediary distributor (ID) 103 that can interact with one or more sponsors 183, independent websites 136, and users 162. In the interactions between the sponsor 183 and the ID 103, the sponsor 183 can send advertisements to the ID 103. The sponsor 183 can send payments to the ID 103 when a user plays the sponsors' advertisement(s). The ID 103 can send a portion of the payment to the copyright holder (not shown) of the sponsored content. The ID 103 may have a network of computers 102, with one or more databases 101 storing media content, advertisements, profiles and histories of users 104, and accounts of one or more sponsors 183 and independent websites 136. The ID 103 may also have one or more secure servers for distribution of media content. In the case of audio media content, the ID 103 may distribute media content from label-certified distributors.

The intermediary distributor (ID) 103 can facilitate the exchange of providing advertisements (and possibly the media content) to users while receiving payment from a sponsor 183 to pay a copyright holder for the media content. The user can receive authorized media content and does not have to pay a fee for accessing the media content. The sponsor 183 can send the advertisement(s) to the ID 103 in advance of the request by the user 162 for media content. When the ID 183 receives advertisement(s) from the sponsor, the ID 103 can ask the sponsor 183 to specify if the advertisement is for a general audience or for a specific targeted audience. If the advertisement is for a specific target audience, then the ID 183 can catalog the advertisement to be distributed to particular user profiles.

In the interactions between the user 162 and the ID 103, the user 162 may register with the ID 103 to create a user profile before the user 162 can be allowed to attempt to make a media content download. In registering with the ID 103 , the user 162 is requested to enter information (e.g., address, email, age, music and movie preferences, student status, etc.) in which the sponsor 183 can use to customize and target their advertisements. For example, suppose the user is 18 years old, lives in New Orleans, has student a status, and prefers Zydeco music. The sponsor 183 may have a Zydeco or Cajun-themed advertisement geared for teenage students that live in the Southeastern portion of the United States. In general, the sponsor 183 may have advertisements targeted for audiences of specific ages (e.g., children, teenagers, young adults, or the like), geographic locations (including local and national locations), employment classifications (e.g., business positions, educational positions, information technology positions, retail positions, or the like), income ranges, demographic information, and the like. The ID 103 may have one or more tools and resources to map or match a user profile to a cataloged advertisement. The matching in the ID 103 may be performed automatically and without intervening human actions.

The ID 103 may also have tools to enable a user to access the media content only after viewing or listening to the advertisement; hence, ensuring that the user upholds the terms of the agreement for accessing the sponsored media content. In terms of audio and video advertisements, the user 162 may be required to play the advertisement before accessing the requested downloaded media content. In one example, the user 162 is required to play the advertisement before the user can download the media content. In another example, the user 162 is required to play the advertisement before the downloaded media content can be played. The user 162 may use a graphical user interface (GUI) 161 to access the media content and play the sponsor's advertisements. In another embodiment, the advertisement must be played in its entirety before the downloaded media content can be played. In another case, the playing of one or more advertisements in their entirety may refer to playing a substantial portion of the advertisement (e.g., playing 25 seconds of a 30 second advertisement), in which the substantial portion can represent the portion of the advertisement in which the primary message of the advertisement is conveyed to the user.

The sponsor 183 may have one or more specifications on how they would prefer for their advertisements to be played. For example, the sponsor 183 may want their advertisements to be played only in conjunction with certain requested media content. For instance, if a user requests media content from artist “X”, the sponsor may have a general contract or agreement to promote (e.g., via commercials, tours, concerts, or the like) artist “X” and may agree to sponsor free downloads for artist “X”. Alternatively, a sponsor may not want to provide users with free downloads of certain artists (e.g., if those artists are specifically sponsored or promoted by another sponsor, or the like). For example, if sponsor “A” sponsors free user downloads for the content of artist “X”, sponsor “B” may not want to provide free user downloads for that same artist. Sponsor “A” and sponsor “B” may be in competing types of businesses (e.g., both sponsors in the retail clothing market) and they may not want to sponsor content downloads for an artist who is promoted by a rival business. The ID 103 can use these preferences and specifications from the sponsors in determining what advertisements are distributed with certain media content downloads.

The user may interact with one or more independent websites 136. The “independent websites” 136 are websites in which the user contacts and interacts with for downloading media content instead of the ID 103. Although the media content may be sent from the ID 103 to the independent websites 136, the independent websites 136, in general, host or store the media content and receive advertisements from the ID 103. The user 162 requests media content from the independent websites 136 directly, and the user agrees to receive and play advertisements from the independent websites 136 in lieu of paying for the requested media content. When the advertisement is played, the ID 103 can send the sponsor 183 notification of the download (e.g., an advertisement has been played by the user). In response, the sponsor 183 can send payment for the downloaded content onto the ID 103, and the ID 103 can pass a portion of the payment along to the independent websites 136. The user receiving the authorized media content does not pay a fee for the media content.

In one implementation, the user 162 only interacts with the independent website, and the ID 103 facilitates the collection of advertisements and payments from the sponsor 183 to send to the independent websites. The ID 183 may also pass one or more sponsor specifications to the independent websites to enable the sponsor to target a particular audience. In some cases, based on the sponsor's specifications, the ID 183 may not send advertisements to particular independent websites (e.g., not to send advertisements to a website for a rival affiliate business).

In some cases the advertisements are not downloaded, but are sent in streaming video format while or after the requested media content downloads. The user does not have the option to close or prematurely terminate the streaming video advertisements, but the advertisement must play in their entirety before the user can access (e.g., play, copy, open or some other user action) the requested media content.

In other cases, the sponsor may have specifications for the user to play more than one advertisement (e.g., web commercial) for certain requested media content. For example, the user may have to play three consecutive different commercials for highly desired media content (e.g., a frequently-requested song download). In other cases, the user may have to play an advertisement that may be extended in time longer than normal for certain requested media content. For example, the user may have to watch a 2-minute commercial instead of a 30-second commercial for a requested video program download (e.g., a music video). Alternatively, the user may be required to play a specified number of minutes of advertisements for a specified number of minutes of requested media content. For instance, the user may be required to watch 1 minute of advertisements for every 4 minutes of requested content.

In general, an intermediary distributor (ID) may facilitate in any of the following scenarios: sending a user requested media content and advertisements from a sponsor that pays for that content; accepting advertisements from a sponsor and payments from that sponsor when media content is accessed by a user; sending payments to independent websites and domains that host media content for users; sending advertisements from a sponsor to the independent websites to be played before the downloaded content can be played; allowing a user to register and maintain an account with the ID; and serving as a client to store and distribute multiple forms of media content and/or advertisements to multiple users. A number of exemplary implementations are described below.

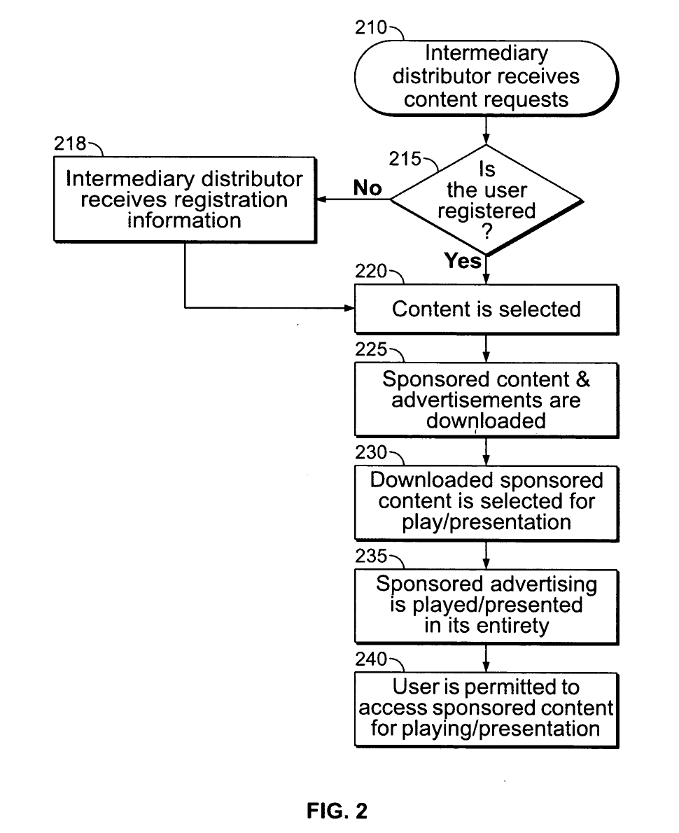

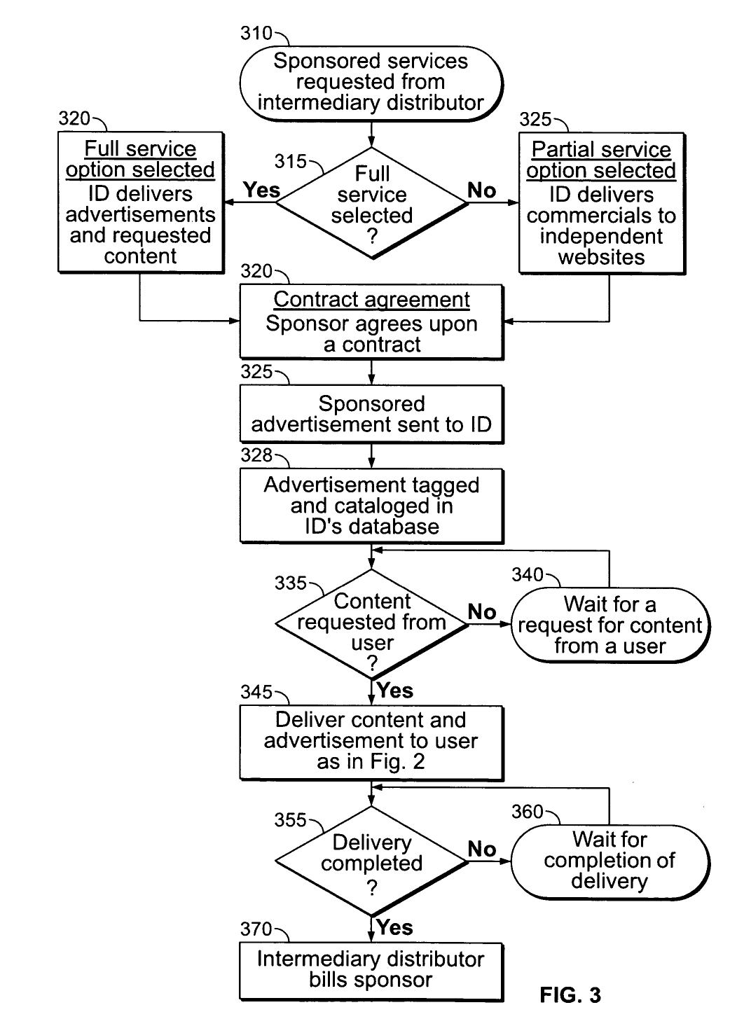

FIG. 2 shows an exemplary flow diagram for a user receiving media content. The ID receives a request for sponsored content from a user (block 210). The ID may have a website with a listing of content (e.g., lists of songs, video clips, video programs, etc.), in which the user can select the content and place the content in their online basket or cart. Alternatively, the user may also select an independent website for content, and the independent website may interact with the ID for payments and advertisements.

After receiving a user's request, the ID checks to see whether the user is registered to receive sponsored content (block 215). If the user is not registered, then the user is prompted to register information for the ID. After the user registers (block 218), the ID creates a user profile. The user profile can allow the ID to easily identify the user and target advertisements based on that user's profile.

A user who has registered may be allowed to select and place content in their online cart (block 220). The user may place a single media content selection or multiple media content selections in the online cart. When the user completes the process of entering one or more requests in their online cart, the ID receives the request and selects one or more advertisements based on the user's profile. The one or more selected advertisements may also be based on the type of selected content (e.g., toy commercials for children's media content). The ID may have a database of cataloged advertisements (e.g., a systematic, organized list of advertisements) from various sponsors and advertisers. The ID can match the content preferences in the user's profile with the advertisement specifications of the sponsor.

The sponsored content and the selected advertisements are then sent to the user (225). In general, the advertisements are sent (or downloaded) to the user before the sponsored content is allowed to be sent (or downloaded). However, the sponsored content and the advertisements may be sent at the same time. In one case, the advertisements may have to be played in streaming video format before (or while) the user downloads the sponsored content. When the user selects to play the downloaded sponsored content (block 230), the advertisements must be played in its entirety before the content can be accessed and played (block 240).

In another implementation, the ID may receive a selection of media content from the user, in which the selection may include one or more items (e.g., files) for downloading. When the user downloads the selection of media content, the user is required to play one or more advertisements in their entirety before accessing the media content. The selection download may include one file package that may be zipped, compressed, and/or may have password security. In one case, the selection of media content may be downloaded before the one or more advertisements are played. However, the user is not allowed to unzip, uncompress, “open”, or “unlock” the selection download until after the one or more advertisements are played in their entirety. If the user does not play the one or more advertisements in their entirety or attempts to prematurely terminate the playing of the one or more advertisements before they reach the end of play, the user is not allowed to “unlock” the selection download. In one example, a user is provided with a password to “unlock” the download and to allow the user to access and play individual media content selections. In another example, the selection download is automatically unlocked after the one or more advertisements are played in their entirety.

In another implementation, the password applies for opening a “locked” selection download (e.g., media content) and may expire after a certain time period (e.g., 48 hours) after the one or more advertisements are played in their entirety. If the selection download is not unlocked within that time period (e.g., 48 hours), the password “expires,” and the user may need to perform another package download.

FIG. 3 shows an exemplary flow diagram for a sponsor sending advertisements to the intermediary distributor. When the sponsor requests to use the services of the intermediary distributor (block 310), the sponsor is provided with an option to select one or more service levels (block 315). If the sponsor selects a full service level (block 320), the ID delivers both advertisements and sponsored content to users. If the sponsor selects a partial service level (block 325), the ID delivers sponsored advertisements to independent websites. After the selection of either case (blocks 320, 325), the sponsor agrees to some terms and conditions with the ID (block 320). The ID may present a list of predefined contract choices for the sponsor in a GUI and the sponsor can select one of those options. The predefined contract choices may include licensing agreements, payment terms, conditions of delivery of advertisements, and the like. The predefined contact choices may vary with the type and size of the sponsor and the quantity of content they are willing to sponsor.

After some agreement(s) have been made between the sponsor and the ID (block 320), the sponsor sends one or more advertisements to the ID (block 325). The sponsor can also send general specification data of how and when they want their advertisements to be played. The sponsor may also send information along with each advertisement of how they want each advertisement to be handled. For instance, the sponsor may have an advertisement for a football product, and the sponsor may specify that the advertisement for the football product should be played only in conjunction with a downloaded sports video clip.

When the ID receives the advertisement, the ID can tag or label each advertisement with a unique identifier (e.g., an alphanumeric identifier). The ID can then categorize the advertisement in a catalog and store the advertisement and the associated information in a registry or database (block 328).

When the ID receives a request for selected content from a user (block 335), the ID delivers the content and/or advertisement as described in regards to FIG. 2 (block 345). When the delivery process has been completed (block 355), and the user plays the advertisement, the ID can bill the sponsor for the content (block 370).

A number of other billing and payment processes may be implemented. For example, the sponsor can be billed when a download has been accessed by the user. Also, the sponsor may pay to sponsor a “bulk” amount of downloads in advance of those downloads. In cases of sponsoring hundreds or thousands of downloads, the “bulk” payment method may significantly reduce the number of billing statements (and/or resources) between the ID and the sponsor. Alternatively, the sponsor can pay for downloads for specific artists and/or on behalf of specific advertisers. Other billing and payment arrangements may be made between the ID, sponsor, and advertisers.

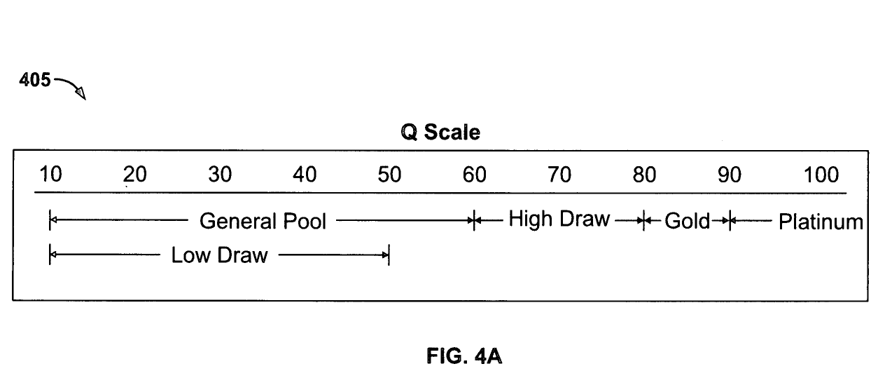

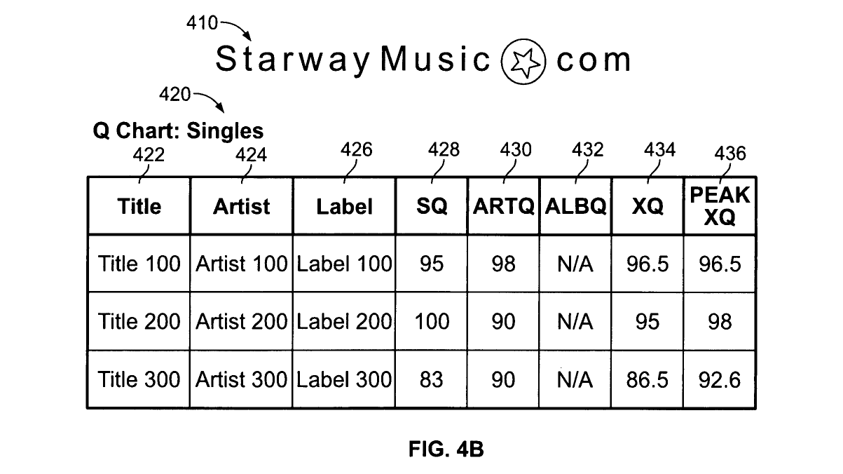

FIGS. 4A and 4B show exemplary diagrams of how the intermediary distributor handles and assesses downloadable media content. FIG. 4A shows an exemplary scale called a “Q Scale” that expresses an assignment of a weight or measure of the popularity of downloaded media content. The scale 405 may present a normalized representation for a number of downloads for a particular media content (e.g., a single song), with the highest level on the scale (e.g., 100) representing a maximum normalized number of downloads per week for any download in that same type of media content (e.g., the most frequently-downloaded single song for a given week).

The scale 405 may have different tiers for several ranges of popularity. For example, a “platinum” tier may have a range of 90 to 100 on the scale, a “gold” tier may have range of 80 to 89 on the scale, a “high draw” tier may have a range of 60 to 79 on the scale, and a “low draw” tier may have a range of 0 to 49 on the scale. There may be overlapping ranges for different tiers. For instance, the “low draw” tier may have a range from 0 to 49 on the scale, and a “general pool” tier may have a range from 0 to 59 on the scale. The “general pool” tier may represent a baseline or default tier which can be used for one or more other measurements.

In one example, the downloaded media content may be songs, and the “Q Scale” may be used to place a measure on a number of songs or “singles” downloaded per week “SQ”. In another example, a measure can be placed on a number of downloads per week for other parameters, such as the number of downloads for various artists “ARTQ” and/or albums “ALBQ”. A measure may also be assigned based on a combination of parameters. For instance, a measure “XQ” can be placed on an average of combined parameters (e.g., “XQ”=“SQ”/3+“ALBQ”/3+“ARTQ”/3).

In one embodiment, prices (e.g., monetary assignments) for the downloads, paid by the sponsor, may be assigned based on the tier of the download. The “general pool” tier may establish a baseline price, and sponsor may be required to pay more for higher level tiers. Alternatively, the scale may be referred to as an “ad tier”, in which one or more advertisements may be assigned based on the tier in the scale. For instance, a user may want to download a frequently-downloaded song, and a sponsor may want high visibility for the advertisements. The more frequently the song is downloaded, the more often the advertisement is played. The sponsor may have to pay more to have their advertisements played along with that song download. The amount of the payment may be proportional to the frequency of the song download (e.g., the “ad tier”).

In another implementation, sponsors may be required to first make a payment to the ID for a “bulk” amount of songs and have that “bulk” number of songs adjusted when users make downloads. For example, say a song download costs $1 per download. A sponsor may pay $10,000 to sponsor 10,000 song downloads in the “general pool” tier. However, downloads for songs in the “high draw” tier may cost $1.25, song downloads in the “gold” tier may cost $1.50, and song downloads in the “platinum” tier may cost $2.00. As users make more downloads, the number of downloads from the $10,000 will be adjusted accordingly based on the popularity of the song. The actual amount of the payments and/or costs of the songs are for example only and may vary in actual implementation.

FIG. 4B illustrates how the Q Scale 405 relates to certain media content (e.g., songs) and other parameters to assess the popularity. The ID 410 may provide a chart of downloadable media content that is based on the Q Scale 405. The chart may include a presentation of music songs (e.g., music singles), artists, albums, video clips, and the like. The chart 420 in FIG. 4B shows a Q chart of music singles 420, in which the chart shows a list of downloadable music titles 422, artists 424, and corresponding labels 426 (e.g., the production company and/or owner of the media content) for each song.

The chart 420 may also include information relating to the Q scale 405, such as a value for the SQ 428, ARTQ 430, ALBQ 432, and XQ 434. If values for the ARTQ 430 or ALBQ 432 are not provided by the ID 410, then the XQ 434 can show the average value for the SQ 428 plus either the ARTQ 430 or ALBQ 432. In some cases, an artist may release a single song and not an album with that song on the album. In that case, an ALBQ 432 value would not exist for that released single. In general, the XQ 434 can show an average measure for a number of parameters relating to the Q scale 405. The Q Chart 420 may also show a peak XQ 436 that can represent the highest XQ achieved for that media content.

The ID 410 can allow the Q Scale 405 in FIG. 4A and the Q Chart 420 in FIG. 4B to be visible to one or more sponsors and/or advertisers. The ID 410 may provide a GUI or portal for each sponsor (and/or advertiser) to access rankings of songs, artists, and albums. The GUI or portal may provide a secure interface. The ID 410 may update the rankings on a periodic basis (e.g., daily, weekly, monthly, annually). The ID 410 may send (e.g., email) reports to sponsors to provide them with information on what they sponsored, an amount and type of download activity, an amount and type of advertisements sponsored and/or played by users, and other metrics. The ID 410 may also provide reports utilizing dashboards, files, and spreadsheets. Reporting information may further include information relating to contracts, campaigns and promotions, marketing, sales, billing and payment, distribution, regulatory and legal affairs, methods of tracking and measuring user activity, and methods of acquiring and storing advertisements and media content on the system of the ID.

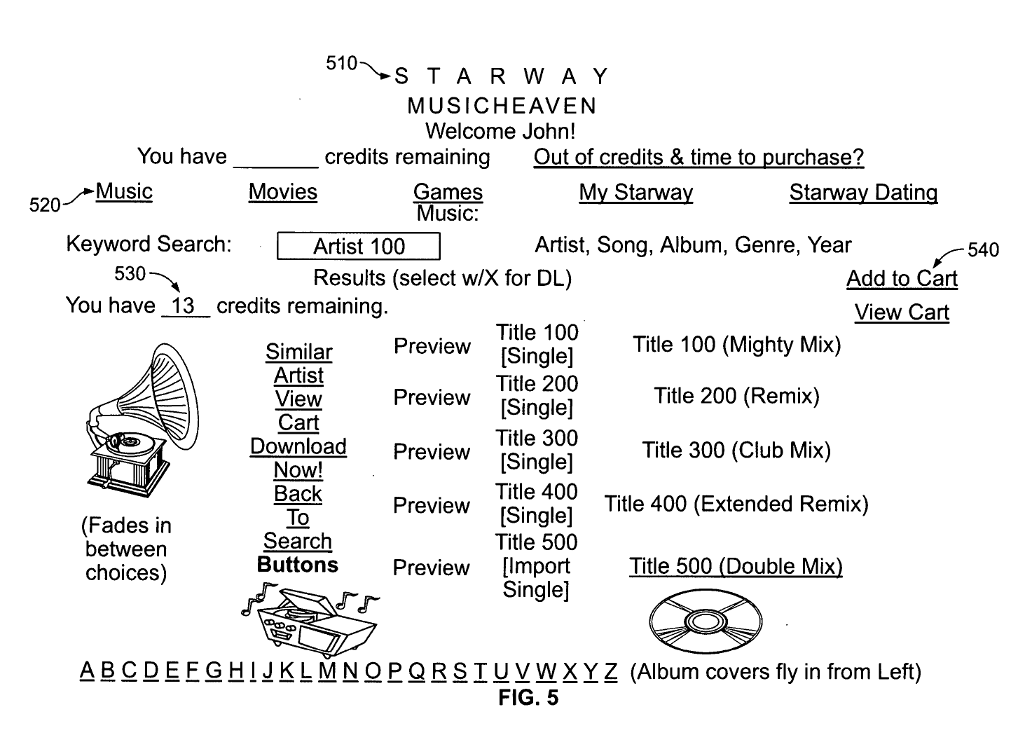

FIG. 5 shows an exemplary user page. After a user has registered and set up an account with the ID 510, the user may be allowed to access links 520 to one or more pages of music, movies, games, and other services (e.g., user account maintenance, dating services). In this implementation, after a user plays an advertisement, a number of “credits” 530 can be added into the user's credit tally. For example, a user may play a streaming video advertisement, and at the completion of that advertisement the user's account can be credited with 3 credits. A user may then select a song single from the ID's database to place in the user's cart 540. The song single may have a number of associated credits, and those credits can be deducted from the user's credit tally. For instance, a download of a song single may require the user to deduct 3 credits from the user's credit tally. When the user downloads the song single, the 3 credits are deducted from the user's account. The number of credits associated with an advertisement and the number of credits associated with a download may vary from described above and could be related to the popularity of the download as shown in the Q scale in FIG. 4A.

In order to prevent a large amount of credits from being accumulated by playing the advertisement over and over (e.g., as if in a loop), then ID may set a limit on the maximum number of credits a user can accumulate. The maximum number of credits may be based on the maximum number of credits a user may accumulate in a time period (e.g., a day), and/or on the maximum number of credits accumulated by playing an advertisement in the time period (e.g., a day). In one implementation, the number of credits accumulated in a time period can be limited to reduce occurrences of fraudulent accumulation of credits (via a program that plays advertisements in a loop).

In another embodiment, the user may not receive the media content without a payment, but rather pays a nominal fee. When a user plays an advertisement, the price of receiving or downloading the media content is reduced, and the user pays a portion (e.g., a percentage like 50% or 20%) of the regular purchase price of the content.

One or more operations described above in reference to the intermediary distributor may be performed with one or more tools of the intermediary distributor. For example, a first tool may enable the authorized downloading of media content for one or more users, and a second tool (e.g., a graphical user interface) can enable the one or more users to register information. A third tool can deliver one or more advertisements to the one or more users. A fourth tool can be used to automatically compensate one or more initial producers (e.g., artists, production companies, copyright holders) of the media content with a portion of the payment from the sponsor. A fifth tool (e.g., a tool utilizing the Q Scale) can enable an assessment of one or more download metrics, such as the frequency of downloads for particular media content. The sixth tool may update and maintain user accounts. The sixth tool may include relevant user information (e.g., a user's download history) and may maintain a number of credits in a user's account as described above. Other operations described above may also be performed with one or more tools of the intermediary distributor.

If one or more advertisements contain video content (e.g., web commercials), the video content may be played in a video-playable viewer (e.g., Windows Media Player for Windows by Microsoft Corporation). The video content may (or may not) be played in a portion of a pop-up (or pop-under) window. If the video content is intended to be played in a pop-up window and a user's system utilizes a pop-up blocking tool, the ID may inform the user (e.g., with a notice window before the download) that the pop-up blocking tool may need to be disabled in order for the one or more advertisements can be played in their entirety.

In another implementation, the ID can work with a search engine provider (e.g., Google Inc. of Mountain View, Calif.) to permit users to search for media content on the search engine. The search engine can identify the media content located at the ID. The user may be able to download the media content by selecting a button or link on the search engine's web page. The download may be conducted through the ID and may include a download package with both the selected media content and one or more advertisements. After the user plays the one or more advertisements in their entirety, the user can then proceed to “unlock” the selected media content portion of the download. A sponsor can pay the ID for the downloaded media content, and the search engine provider may receive a portion of that payment via the ID.

As used herein, media content may refer to any of the following: audio content, (e.g., music and recordings), video content (e.g., video programs, movies, commercials, video clips, or the like), gaming content (e.g., interactive games, and multi-player games), and content (e.g., literature/reading materials, educational products, or the like) that can be stored on a digital medium (such as compact disc, DVD, or a computer memory, or the like) and/or downloaded from a webpage. Media content may also refer to content that can be sent in a video stream to a client computer, and content that is transferable over email, chat sessions, file transferring programs, and file sharing programs.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The software (also known as programs, software tools or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on one or more computers each having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface, portal, or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), a wireless local area network (“WLAN”), a personal area network (“PAN”), a mobile communication network using a multiple access technology (e.g., a cellular phone network with Code Division Multiple Access, “CDMA”), and the Internet.

As used herein, a computer may also refer to any general-purpose machine that processes data according to a set of instructions that is stored internally either temporarily or permanently, including, but not limited to, a general-purpose computer, workstation, laptop computer, personal computer, set top box, Internet-ready mobile phones, wired or wireless laptop computers, smart client devices (that actively fetch data and store it locally), wireless devices (such as a personal digital assistant (“PDA”), a cellular or mobile telephone, an electronic handheld unit for the wireless receipt and/or transmission of data, a media content playable device (e.g., iPod™ from Apple Computer, Inc. of Cupertino, Calif.), or the like.

The computing system can include clients and servers. A client and server are generally remote from each other and typically interact through a communication network. The relationship of client and server arises by virtue of computer programs running on the respective computers and having a client-server relationship to each other.

Although only a few implementations have been described in detail above, other modifications are possible. There may be other scenarios that have not been described. For example, instead of having a song single to be downloaded to the user's computer, a CD of the song single could be mailed to the user, upon the user's viewing of the advertisement. In another case, the ID may utilize a wizard utility to help a user, sponsor, and/or advertiser to set up and/or register an account. The sponsor may receive a monthly video report that shows details of sponsored activities. A user's profile may include information (e.g., picture, biography, links to personal web pages, email, favorite hobbies, zodiac sign, location of residence, chat buddies) to enable them to participate in dating services. A user may play advertisements to obtain a discount, a rebate, a gift card, or a coupon for media content from one or more media content providers and/or advertisers. The user interfaces described above may be referred to as panels, palettes, pages, views, or portions of other interfaces.

The steps depicted in flow charts and methods herein may be performed in a different order than as depicted and/or stated. The steps shown herein are merely exemplary of the order these steps may occur. The steps shown herein may occur in any order that is desired, such that the goals of the claimed invention are still achieved. Additionally, steps not desired to be used from the steps shown in the flow charts and methods may be eliminated, such that the goals of the claimed invention are still achieved. For example, the logic flow depicted in FIG. 3 does not require the particular order shown, or sequential order, to achieve desirable results.

Other implementations may be within the scope of the following claims.

1. A method comprising:
receiving a selection of media content from a graphical user interface, wherein the media content is configured to be downloadable onto one or more computers;
providing one or more advertisements capable of being played on the one or more computers; and
providing access to the media content upon playing the one or more advertisements in their entirety, wherein a fee for the media content is received from a sponsor in exchange for a user playing the one or more advertisements in their entirety before the media content is accessed.

2. The method of claim 1 wherein the providing access to the media content upon playing the one or more advertisements in their entirety comprises downloading the media content after playing the one or more advertisements in their entirety.

3. The method of claim 1 wherein the providing access to the media content upon playing the one or more advertisements in their entirety comprises downloading the media content during the same time as playing the one or more advertisements in their entirety.

4. The method of claim 1 wherein the providing access to the media content upon playing the one or more advertisements in their entirety comprises downloading the media content before playing the one or more advertisements in their entirety, wherein the download comprises locked media content, and wherein the user is prevented from unlocking the media content until after the user plays the one or more advertisements in their entirety.

5. The method of claim 1 wherein the providing access to the media content upon playing the one or more advertisements in their entirety comprises downloading the media content and the one or more advertisements in a package download, wherein the package download comprises locked media content, and wherein the user is prevented from unlocking the media content until after the user plays the one or more advertisements in their entirety.

6. The method of claim 1 wherein the user receives the media content without paying a fee for the media content.

7. The method of claim 1 wherein the providing access to the media content comprises downloading the media content.

8. The method of claim 1 wherein the selection of media content comprises a plurality of individual media content selections.

9. The method of claim 1 wherein the media content comprises any one or more of audio content, video content, text-based content, gaming content, and any combination of audio content, video content, text-based content, and gaming content.

10. The method of claim 1 wherein the sponsor passes the one or more advertisements to an intermediary distributor, and wherein the intermediary distributor delivers the one or more advertisements to the user upon receiving the one or more advertisements from the sponsor.

11. The method of claim 10 wherein the intermediary distributor categories the one or more advertisements and delivers the one or more advertisements based on one or more specifications of the sponsor.

12. The method of claim 11 wherein the one or more advertisements are targeted for one or more user preferences, wherein the one or more advertisements are tailored to one or more user profiles.

13. The method of claim 1 further comprising requiring the user to register user information before selecting the media content, wherein the user information comprises one or more user preferences and an email address.

14. The method of claim 1 wherein the media content is selected from an independent website, wherein the independent website hosts the media content and an intermediary distributor is adapted to deliver the one or more advertisements.

15. The method of claim 1 wherein receiving the selection of media content from a graphical user interface comprises selecting the selection of media content from an intermediary distributor, and wherein the intermediary distributor is adapted to deliver the media content and the one or more advertisements to the user.

16. The method of claim 1 wherein an intermediary distributor receives the fee from the sponsor and compensates one or more initial owners and producers of the media content with a portion of the fee.

17. The method of claim 16 wherein the download of the media content is authorized by the one or more initial owners and producers of the media content.

18. The method of claim 1 wherein the one or more advertisements are played in streaming video format.

19. The method of claim 1 wherein the playing one or more advertisements in their entirety comprises not permitting a user to terminate the playing of the one or more advertisements until the one or more advertisements have reached the end of play.

20. A system comprising:
a user interface adapted to collect data from a user, wherein the collected data comprises one or more selections for downloadable media content;
an intermediary distributor adapted to send one or more advertisements to the user; and
a sponsor to compensate the intermediary distributor for the downloadable media content in exchange for the user playing the one or more advertisements in their entirety, wherein the user does not pay a fee to download the downloadable media content.

21. The system of claim 20 wherein the intermediary distributor comprises a database adapted to store a plurality of media content and advertisements, wherein the one or more advertisements are categorized based on one or more specifications of one or more sponsors.

22. The system of claim 21 wherein the intermediary distributor is further adapted to provide the downloadable media content to the user.

23. The system of claim 20 wherein the intermediary distributor is further adapted to receive the one or more advertisements from any one of a sponsor and an advertiser.

24. The system of claim 20 further comprising an independent website, wherein the independent website is adapted to host the downloadable media content, wherein the intermediary distributor is adapted to pass one or more advertisements to the independent website, and wherein the user interacts with the independent website for downloading media content.

25. The system of claim 20 wherein the one or more advertisements are played in streaming video format.

26. The system of claim 20 wherein the one or more advertisements are downloaded to a user's computer prior to playing.

27. The system of claim 20 wherein the system is adapted to provide authorized downloads of the downloadable media content.

28. The system of claim 27 wherein the downloadable media content comprises any one or more of audio content, video content, text-based content, gaming content, and any combination of audio content, video content, text-based content, and gaming content.

29. The system of claim 20 wherein the one or more advertisements are targeted for the user, and wherein the intermediary distributor comprises one or more tools and resources to match a user profile to cataloged advertisements in an intermediary distributor's database.

30. The system of claim 29 wherein the intermediary distributor is further adapted to provide a ranking of downloadable media content to the sponsor based on a frequency of download.

31. A system comprising:
a first tool to enable the authorized downloading of media content for one or more users;
a second tool to enable the one or more users to register user information; and
a third tool to deliver one or more advertisements to the one or more users, wherein the authorized downloading of media content is agreed to be paid by a sponsor that requires the one or more users to play the one or more advertisements in their entirety before accessing the media content.

32. The system of claim 31 wherein the system is configured to enable the authorized downloading of media content to one or more users without requiring a fee from the one or more users for the media content after the one or more users play the one or more advertisements in their entirety.

33. The system of claim 31 wherein the system is configured to enable the authorized downloading of media content and reduce a fee for the one or more users for the media content after the one or more users play the one or more advertisements in their entirety.

34. The system of claim 31 wherein the system further comprises a graphical user interface, wherein the graphical user interface is adapted to enable a user to select media content for downloading.

35. The system of claim 31 further comprising a fourth tool to automatically compensate one or more initial producers of the media content with a portion of the payment from the sponsor.

36. The system of claim 31 further comprising a fifth tool to enable an assessment of a frequency of downloads.

37. The system of claim 36 wherein the fifth tool comprises a scale with one or more ranges of popularity, wherein the one or more ranges of popularity comprises a number of downloads in a given time frame.

38. The system of clam 36 wherein the fifth tool further comprises one or more download parameters, wherein one or more advertisements are assigned based on the one or more ranges of popularity.

39. The system of claim 31 further comprises a sixth tool that maintains a number of credits in a user's account based on a number of advertisements played and a number of downloaded media content, wherein the playing of an advertisement adds credits to the user's account and the downloading of media content deducts credits from the user's account.

40. The system of claim 31 wherein the sponsor is charged for the authorized downloading of media content.

41. A method comprising:
receiving a selection of media content from a graphical user interface, wherein the media content is configured to be downloadable onto one or more computers;
providing one or more advertisements capable of being played on the one or more computers; and
providing access to the media content upon playing the one or more advertisements in their entirety, wherein a sponsor agrees to provide compensation for the media content in exchange for a user playing the one or more advertisements in their entirety before the media content is accessed, wherein the compensation is a payment to at least one of an intermediary distributor and one or more initial owners and producers of the media content.

42. An article comprising a machine-readable medium storing instructions operable to cause a machine to perform operations comprising:
receiving a selection of media content from a graphical user interface, wherein the media content is configured to be downloadable onto one or more computers;
providing one or more advertisements capable of being played on the one or more computers; and
providing access to the media content upon playing the one or more advertisements in their entirety, wherein a fee for the media content is received from a sponsor in exchange for a user playing the one or more advertisements in their entirety before the media content is accessed.
